(19) United States
(12) Patent Application Publication
(10) Pub. No.: US 2019/0025222 A1
(43) Pub. Date: Jan. 24, 2019

(54) COMPOSITION FOR FINGERPRINT DETECTION

(71) Applicant: ABDULLAH ALDASEM, SAFAT (KW)

(72) Inventor: ABDULLAH ALDASEM, SAFAT (KW)

(21) Appl. No.: 16/044,467

(22) Filed: Jul. 24, 2018

Related U.S. Application Data
(60) Provisional application No. 62/536,328, filed on Jul. 24, 2017.

(51) Int. Cl. G01N 21/78

(52) U.S. Cl. CPC G01N 21/78

(57) ABSTRACT

The composition for fingerprint detection is a ninhydrin-based fingerprint detection composition. The composition includes ninhydrin and 1.0% acetic acid in acetone. The ninhydrin has a concentration between 0.55% (w/v) and 0.65% (w/v) of the overall composition for fingerprint detection. When the composition is applied to a surface having a latent fingerprint thereon, the developed prints are a high-contrast purple that is readily visible on most paper backgrounds. The developed fingerprint may then be recorded and/or preserved.

### CROSS-REFERENCE TO RELATED APPLICATION

This application claims the benefit of U.S. Provisional Patent Application Ser. No. 62/536,328, filed on Jul. 24, 2017.

### BACKGROUND

### 1. Field

The disclosure of the present patent application relates to the detection of latent fingerprints, and particularly to a composition for fingerprint detection that includes a mixture of ninhydrin, acetic acid and acetone.

### 2. Description of the Related Art

Ninhydrin (2,2-dihydroxyindane-1,3-dione) is a chemical used to detect ammonia or primary and secondary amines. When reacting with these free amines, a deep blue or purple color known as “Ruhemann's purple” is produced. Ninhydrin is commonly used to detect fingerprints, as the terminal amines of lysine residues in peptides and proteins sloughed off in fingerprints react with ninhydrin. Ninhydrin is a white solid, which is soluble in ethanol and acetone at room temperature. Due to the unique conditions in hot, dry and windy environments, such as those found in the Middle East and similar arid climates, using ninhydrin powder may present difficulties, particularly when used outdoors. Thus, a composition for fingerprint detection addressing the aforementioned problems is desired.

### SUMMARY

The composition for fingerprint detection is a ninhydrin-based fingerprint detection composition. The composition includes ninhydrin and 1.0% acetic acid in acetone. The ninhydrin has a concentration between 0.55% (W/V) and 0.65% (W/V) of the overall composition for fingerprint detection. When preparing the composition, the ninhydrin is added to the 1.0% acetic acid in acetone, and this mixture is shaken thoroughly. When the composition is applied to a surface having a latent fingerprint thereon, the developed prints are a high-contrast purple that is readily visible on most paper backgrounds. The developed fingerprint may then be recorded and/or preserved.

These and other features of the present disclosure will become readily apparent upon further review of the following specification.

### DETAILED DESCRIPTION OF THE PREFERRED EMBODIMENTS

The composition for fingerprint detection is a ninhydrin-based fingerprint detection composition. The composition includes ninhydrin and 1.0% acetic acid in acetone. The ninhydrin has a concentration between 0.55% (w/v) and 0.65% (w/v) of the overall composition for fingerprint detection. Following mixing of the ninhydrin, acetone and acetic acid, the mixture is shaken thoroughly.

The composition for fingerprint detection is particularly useful for making fingerprints on porous surfaces, such as paper and cardboard, visible, but may be used on other surfaces as well. The composition may be applied to the surface by any suitable method, such as brushing or spraying. When the composition is applied to a surface having a latent fingerprint thereon, the developed prints are a high-contrast purple that is readily visible on most paper backgrounds. The developed fingerprint may then be recorded and/or preserved.

It is to be understood that the composition for fingerprint detection is not limited to the specific embodiments described above, but encompass any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A composition for fingerprint detection, comprising between 0.55% (w/v) and 0.65% (w/v) ninhydrin and 1.0% acetic acid in acetone.

2. A composition for fingerprint detection, consisting essentially of between 0.55% (w/v) and 0.65% (w/v) ninhydrin and 1.0% acetic acid in acetone.

3. A method of detecting fingerprints, comprising the step of applying a fingerprint-detecting composition to a surface having a latent fingerprint thereon, the fingerprint-detecting composition consisting essentially of between 0.55% (w/v) and 0.65% (w/v) ninhydrin and 1.0% acetic acid in acetone.

4. The method of detecting fingerprints as recited in claim 3, wherein the surface having the latent fingerprint thereon is a porous surface.
